(19) United States
(12) Patent Application Publication
(10) Pub. No.: US 2013/0145075 A1
(43) Pub. Date: Jun. 6, 2013

(54) DYNAMICALLY MANAGING MEMORY LIFESPAN IN HYBRID STORAGE CONFIGURATIONS

(71) Applicants: Wei Huang, Austin, TX (US); Anthony Nelson Hylick, Austin, TX (US)

(72) Inventors: Wei Huang, Austin, TX (US); Anthony Nelson Hylick, Austin, TX (US)

(73) Assignee: International Business Machines Corporation, Armonk, NY (US)

(21) Appl. No.: 13/308,773

(22) Filed: Dec. 1, 2011

(51) Int. Cl. G06F 12/00

(52) U.S. Cl. 711/103; 711/167; 711/159; 711/E12.008; 711/E12.078

(57) ABSTRACT

A system, and computer program product for managing the lifespan of a memory using a hybrid storage configuration are provided in the illustrative embodiments. A throttling rate is set to a first value for processing memory operations in the memory device. The first value is set using a health data of the memory device for determining the first value. A determination is made whether a memory operation can be performed on the memory device within the first value of the throttling rate, the first value of the throttling rate allowing a first number of memory operations using the memory device per time period. In response to the determining being negative, the memory operation is performed using a secondary storage device.

### BACKGROUND

1. Technical Field

The present invention relates generally to a computer implemented method, system, and computer program product for improving the use of computing resources. Particularly, the present invention relates to a computer implemented method, system, and computer program product for managing the lifespan of a memory using a hybrid storage configuration.

2. Description of the Related Art

A data processing system uses memory for storing data used by an application. Data is written into a memory using a write operation (write).

As with any electronic component, use of a memory causes wear on the electronic components of the memory. Eventually, one or more components in the memory fail from the wear rendering the memory unreliable or unusable.

A length of time from the time the memory is deployed, to the time the memory is deemed to become unreliable or unusable from use is called a lifespan of the memory. A lifespan of a memory does not necessarily indicate the actual time before failure for a particular memory unit but only an expected time before failure (expected lifespan). A memory manufacturer may determine the average lifespan of a type of memory units through testing, and may suggest an expected lifespan for an average memory unit of the type of memory units tested.

### SUMMARY

The illustrative embodiments provide a method, system, and computer program product for managing the lifespan of a memory using a hybrid storage configuration. An embodiment sets, using a processor, at an application executing in a data processing system, a throttling rate to a first value for processing memory operations in the memory device, the setting using a health data of the memory device for determining the first value. The embodiment determines whether a memory operation can be performed on the memory device within the first value of the throttling rate, the first value of the throttling rate allowing a first number of memory operations using the memory device per time period. The embodiment performs, responsive to the determining being negative, the memory operation using a secondary storage device.

### BRIEF DESCRIPTION OF THE SEVERAL VIEWS OF THE DRAWINGS

The novel features believed characteristic of the embodiments are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts an example configuration for managing a memory lifespan in accordance with an illustrative embodiment;

FIG. 4 depicts a flowchart of a process of managing the lifespan of a memory using a hybrid storage configuration in accordance with an illustrative embodiment; and

FIG. 5 depicts a process of dynamically adjusting a throttling rate in accordance with an illustrative embodiment.

### DETAILED DESCRIPTION

A write operation according to an embodiment writes data into a memory device. Writing to a memory device can occur under two conditions—when a thread or a process executing in the data processing system writes data to the memory device, and when a read miss occurs while reading the memory and data is brought in from a secondary storage and written into the memory device.

Certain memories have their lifespan specified in terms of a number of write operations that can be performed using the memory before the memory is expected to develop an error that ends the memory's useful lifespan. Such a memory is called a write-limited memory in this disclosure.

The illustrative embodiments recognize that a memory's lifespan is an indicator of only the average expectancy of the memory's useful life and can change due to a manner of using the memory. For example, in a write-limited memory, writing to a particular memory cell more frequently than other cells may cause the memory to become unreliable before a specified number of write operations in the memory's lifespan.

The wear on memory cells is not only a result of data written to a cell (direct write operation). Presently, wear-leveling technology exists to distribute the data writing operations to the various memory cells evenly. However, the illustrative embodiments recognize that the presently used wear-leveling technology does not account for cell to cell variations or interference. A cell to cell variation is an adverse effect on cell—cell A (indirect write operation)—when a write operation is conducted in a neighboring cell—cell B. The illustrative embodiments recognize that cell-to-cell variation adversely affects the lifespan of write-limited memories, because even though a write may occur at cell B as a direct write operation on cell B, a neighboring cell A experiences the effects of the write operation as an indirect write operation on cell A. Thus, the overall effect of a write operation can be greater than a single count of write operation. Current wear-leveling technology only distributes the operations to various cells, but does not account for cell to cell variations.

The illustrative embodiments further recognize that the endurance of a memory cell is also dependent upon the data pattern being written to or read from neighboring cells. Again, a lifespan of a memory may be reduced when certain data patterns written to or read from one memory cell also adversely affects a neighboring cell, causing more than an single read or write count worth of wear on the memory. The illustrative embodiments recognize that current wear-leveling technology does not account for such pattern dependent affects on neighboring cells.

The illustrative embodiments also recognize that performing a number of write operations on a memory in one period has a different effect on the lifespan of the memory than performing the same number of write operations in a smaller period. For example, a burst of 100 write operations in one second is more detrimental to the lifespan of the memory than performing the same 100 write operations over 10 seconds, regardless of which cells are selected for performing those operations. The illustrative embodiments recognize that presently available wear-leveling technology does not consider such burst operations in distributing the memory operations.

The illustrative embodiments used to describe the invention generally address and solve the above-described problems and other problems related to managing the lifespan of memories. The illustrative embodiments provide a method, system, and computer program product for managing the lifespan of a memory using a hybrid storage configuration.

An illustrative embodiment throttles the memory operations according to a write rate—a rate of writing to memory. The write rate is determined based on the specified or expected lifespan of the memory, desired lifespan of the memory, the health of the memory, or a combination thereof. For example, an embodiment can set an initial rate of write operations using an expected lifespan, and change the write rate based on the health of the memory. The write rate is a component of a usage rate, which is a rate of using the memory for a variety of operations, including but not limited to read operations and write operations.

The health of the memory includes factors such as cell to cell variations to regulate the write rate. If an embodiment receives a memory operation requests at a rate greater than the write rate, the embodiment diverts the excess operations to a secondary data storage, such as another tier of memory, hard disk, optical storage, or a combination of these and other suitable data storage devices.

The illustrative embodiments are described with respect to certain computing resources only as examples. Such descriptions are not intended to be limiting on the illustrative embodiments. For example, certain illustrative embodiments are described using write operations in a write-limited memory only as an example scenario where the illustrative embodiments are applicable, without implying a limitation of the illustrative embodiments thereto. An embodiment can be used for throttling other types of memory operations in a similar manner, on memories whose lifespan can be translated into a number of memory operations.

Similarly, the illustrative embodiments are described with respect to certain lifespan factors only as examples. Such descriptions are not intended to be limiting on the illustrative embodiments. For example, an illustrative embodiment described with respect to a cell to cell variation effect from write operations in a neighboring cell can be implemented with a cell to cell variant effect on a cell from a read operation in a neighboring cell, or interference from storage of certain data pattern in a neighboring cell within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are further described with respect to certain applications only as examples. Such descriptions are not intended to be limiting on the invention. An embodiment of the invention may be implemented with respect to any type of application, such as, for example, applications that are served, the instances of any type of server application, a platform application, a stand-alone application, an administration application, or a combination thereof.

An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of computing resource, such as a physical or virtual data processing system or components thereof, that may be available in a given computing environment.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

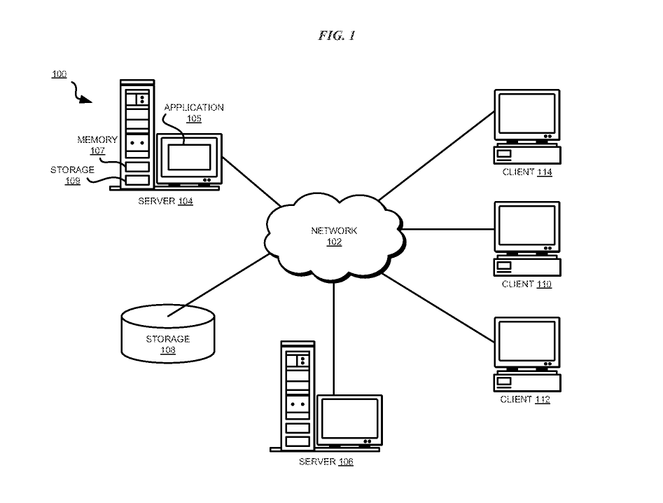

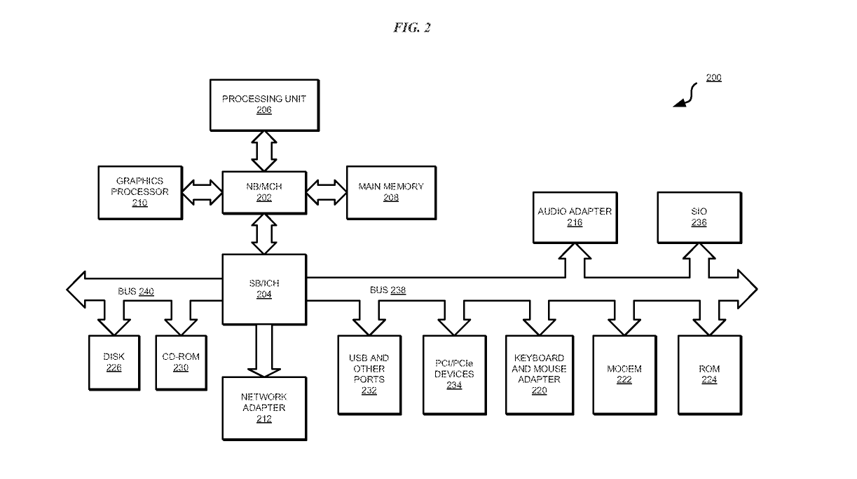

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

A data processing system, such as server 104, may include application 105 executing thereon. Application 105 may be an application for managing memory 107 component of server 104 in accordance with an embodiment. Storage 109 may be any combination of data storage devices, such as a memory or a hard disk, which can be used by an embodiment as a secondary storage. Application 105 may be any suitable application in any combination of hardware and software for managing a memory, including but not limited to a memory manager component of an operating system kernel. Application 105 may be modified to implement an embodiment of the invention described herein. Alternatively, application 105 may operate in conjunction with another application (not shown) that implements an embodiment.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller huh 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

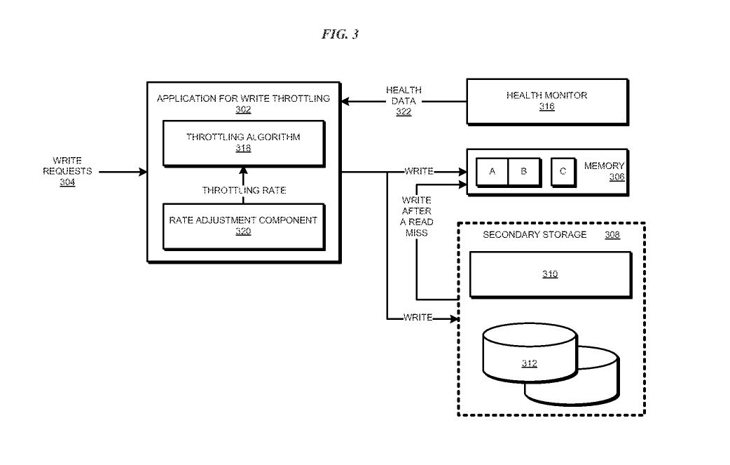

With reference to FIG. 3, this figure depicts an example configuration for managing a memory lifespan in accordance with an illustrative embodiment. Application 302 is analogous to application 105 in FIG. 1.

The embodiments are described using write requests, write operations, and write-limited memory as examples for the clarity of the description, and not as limitations on the embodiments. An embodiment can be implemented with other memory access requests, other memory operations, and other memories whose lifespan is defined in other ways.

Application 302 is an application for throttling the write operations directed to memory 306. Application 302 receives write requests 304 for writing data to memory 306. Memory 306 is a write-limited memory unit that has a lifespan of a threshold number of write operations over the useful life of memory 306. Memory 306 includes cells A, B, and C as shown. Operations, such as write operations in cell B can affect cell A or cell C through cell to cell variation as recognized by the illustrative embodiments.

Secondary storage 308 includes any suitable type of data storage devices in the manner of storage 109 in FIG. 1. For example, as depicted, secondary storage 308 includes memory 310 and disk storage 312.

Health monitor 316 is a utility that measures certain parameters of a memory, such as temperature, number of operations, electrical characteristics, a combination thereof, or other parameters usable for determining use-related wear, of memory cells in memory 306. Health monitor 306 can perform the measurements periodically, upon an event, or a combination thereof. In one embodiment, health monitor 316 includes a fabricated circuit on memory 306 that is in a firmware implementation of health monitor 316. In another embodiment, health monitor 316 is an application that uses health/performance/operational data output from memory 306.

Application 302 includes throttling algorithm 318 and rate adjustment component 320. Throttling algorithm 318 may be any suitable algorithm for ensuring that a rate of write operations directed to memory 306 does not exceed the rate set by rate adjustment component 320.

As an example, throttling algorithm 318 may be an implementation of Token Bucket algorithm. Generally, an implementation of Token Bucket algorithm maintains a data container (the metaphorical “bucket”) in which data tokens (tokens) are deposited at a determined rate.

In accordance with an embodiment that employs the Token Bucket algorithm, if at a time of write request 304, a token exists in the token bucket, the write operation of that write request 304 can proceed. A token is removed from the bucket for each write request 304 that proceeds for processing to memory 306.

If no tokens exist in the token bucket at the time of write request 304, the write request is diverted to secondary storage 308. Later, such as when memory 306 is idle or extra tokens are available in the bucket, the data of the diverted write operation can be moved from secondary storage 308 to memory 306 using a token. In this manner, the rate of performing write operations cannot exceed the rate in throttling algorithm component 318 regardless of the rate at which write requests 304 are received at application 302.

In accordance with an embodiment, advantageously, the rate used by throttling algorithm component 318 is dynamically adjustable. Rate adjustment component 320 provides and updates the rate at which throttling algorithm component 318 has to throttle write requests 304. In one embodiment, rate adjustment component 320 determines the rate change by factoring in health data 322 received at application 302 from health monitor 316.

Generally, rate adjustment component 320 computes an average rate of write operations that should be performed on memory 306 according to a desired or specified lifespan of memory 306. Rate adjustment component 320 sets and adjusts that throttling rate for write requests 304 depending upon the workload on memory 306 to ensure that the average rate of write operations on memory 306 is achieved.

For example, under certain circumstances, owing to health data 322, rate adjustment component 320 may determine that cell to cell variation in memory 306 is causing more wear for a write operation than a single write operation. Accordingly, rate adjustment component 320 reduces the write rate from a previous value to a new value such that fewer write requests 304 are directed to memory 306 according to the new value than would be according to the previous value. Conversely, rate adjustment component 320 can increase the write rate from a previous value to a new value under certain circumstances, such as after a prolonged over-throttling (i.e., after sending fewer operations to memory 306 in a period than memory 306 could process without adversely changing the average rate).

Component 320's adjustment of the throttling rate is automatic in that no user action is required to effect the adjustment. Component 320's adjustment of the throttling rate is dynamic because the throttling rate is adjusted responsive to the changing health conditions of memory 306. In other words, the throttling rate is not preset, or changeable only at reboot, but can be changed at runtime depending on the workloads and health of memory 306.

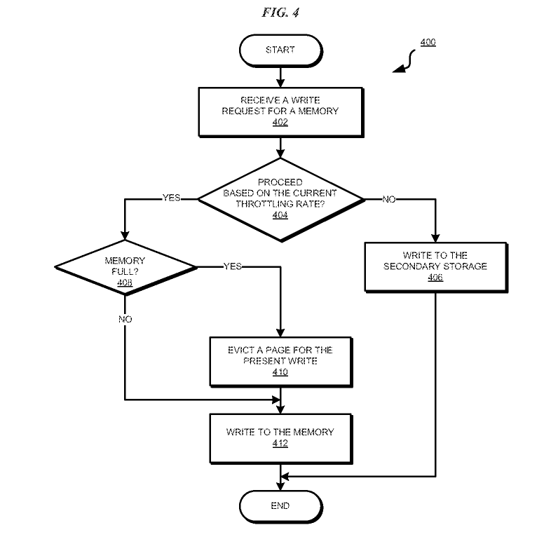

With reference to FIG. 4, this figure depicts a flowchart of a process of managing the lifespan of a memory using a hybrid storage configuration in accordance with an illustrative embodiment. Process 400 can be implemented in application 302 in FIG. 3.

Process 400 begins by receiving a write request for a memory under management (step 402). Process 400 determines whether the write request can proceed based on the currently set throttling rate (step 404). For example, if process 400 uses a Token Bucket algorithm, process 400 determines at step 404 whether a token is available in the bucket.

If the write request of step 402 cannot proceed, such as when a token is not available in the bucket (“No” path of step 404), process 400 diverts the write to the secondary storage (step 406). Process 400 ends thereafter.

If the write request can proceed to the memory under management (“Yes” path of step 404), process 400 determines whether the memory is full (step 408). If the memory is full (“Yes” path of step 408), process 400 evicts a page from the memory to accommodate the data of the write request (step 410). Process 400 then performs the write request according to the write request of step 402 (step 412). Process 400 ends thereafter. If the memory is not full, i.e., the write operation can be performed without evicting a page from the memory (“No” path of step 408), process 400 performs the write operation at step 412 and ends thereafter.

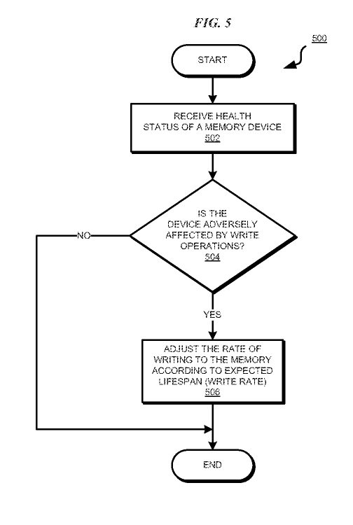

With reference to FIG. 5, this figure depicts a process of dynamically adjusting a throttling rate in accordance with an illustrative embodiment. Process 500 can be implemented in application 302 in FIG. 3. Although process 500 is depicted as a single pass, start-to-end operation, an implementation of process 500 can be iterative, where process 500 is repeated periodically or upon certain events.

Process 500 begins by receiving a health status of a memory under management (step 502). For example, in one embodiment, process 500 receives health data 322 in FIG. 3. Health data 322 in FIG. 3 may be indicative of a health status of memory 306, which is degraded by a cell to cell variation on cell A in memory 306 due to write operations in neighboring cell B in memory 306 in FIG. 3.

Process 500 determines whether the memory is adversely affected by memory operations, such as direct or indirect write operations in cells (step 504). If the cell is not adversely affected by memory operations by direct or indirect writes (“No” path of step 504), process 500 ends thereafter. In other words, process 500 leaves the throttling rate unchanged from a previous value. In one embodiment (not shown), if the cell is not adversely affected by memory operations, the embodiment may adjust the throttling rate by increasing the rate of write operations to the memory.

Generally, an increase in the throttling rate can be made in any manner suitable depending upon the throttling algorithm being used. For example, when process 500 is used in conjunction with Token Bucket algorithm, process 500 can increase (or decrease) the write rate by increasing (or decreasing) the rate at which tokens are deposited in the bucket.

If the cell is adversely affected by direct or indirect write memory operations (“Yes” path of step 504), process 500 adjusts the rate of writing to the memory, such as by decreasing the rate of write operations (step 506). Process 500 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for managing the lifespan of a memory using a hybrid storage configuration. Using an embodiment, a hybrid configuration of a memory and a secondary storage is used to avoid premature wear out of the memory device. An embodiment monitors the wear-out characteristics, such as the number of writes in a write-limited memory device, in conjunction with the workload on the memory device, the health of memory device, and a desired lifespan of the memory device. The embodiment throttles the memory device's usage to avoid exceeding an average usage rate, that corresponds to the desired lifespan. Note that a specified lifespan may be different from a desired lifespan of the memory device.

The embodiments are described using one tier of memory that has to be monitored for wear-out only as an example. An embodiment can adjust more than one throttling rates for more than one managed memory units in multi-tier memory architecture. The multi-tier memory architecture can include memory units of same or different lifespan expectancy within the scope of the illustrative embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1-10. (canceled)

11. A computer usable program product comprising a computer usable storage medium including computer usable code for managing a lifespan of a memory device, the computer usable code comprising:
computer usable code for setting, using a processor, at an application executing in a data processing system, a throttling rate to a first value for processing memory operations in the memory device, the setting using a health data of the memory device for determining the first value;
computer usable code for determining whether a memory operation can be performed on the memory device within the first value of the throttling rate, the first value of the throttling rate allowing a first number of memory operations using the memory device per time period; and
computer usable code for performing, responsive to the determining being negative, the memory operation using a secondary storage device.

12. The computer usable program product of claim 11, further comprising:
computer usable code for receiving the request for the memory operation, wherein the memory operations are write operations resulting from one of (i) a process writing data to the memory device, and (ii) a read miss occurring at the memory device wherein the request for the memory operation is a to write data to the memory device from the secondary storage.

13. The computer usable program product of claim 11, wherein the throttling rate is configured to achieve an average rate of performing the memory operations over the lifespan of the memory device.

14. The computer usable program product of claim 11, further comprising:
computer usable code for determining whether the health data of the memory device indicates a wear on a cell due to cell to cell variation in the memory device from another memory operation in another cell in a neighborhood of the cell; and
computer usable code for reducing, responsive to determining that the health data of the memory device indicates the wear, the throttling rate from the first value to a second value such that a number of memory operations performed in the memory device is smaller with the throttling rate set to the second value than the first value.

15. The computer usable program product of claim 11, further comprising:
computer usable code for determining whether the health data of the memory device indicates a wear on a cell due to a direct write operation to that cell in the memory device; and
computer usable code for reducing, responsive to determining that the health data of the memory device indicates the wear, the throttling rate from the first value to a second value such that a number of memory operations performed in the memory device is smaller with the throttling rate set to the second value than the first value.

16. The computer usable program product of claim 11, further comprising:
computer usable code for determining whether the health data of the memory device indicates, as compared to an expected wear according to an expected lifespan of the memory device, an increased wear on a cell due to cell to cell variation in the memory device from another memory operation in another cell in a neighborhood of the cell; and
computer usable code for increasing, responsive to determining that the health data of the memory device does not indicate the increased wear, the throttling rate from the first value to a third value such that a number of memory operations performed in the memory device is larger with the throttling rate set to the third value than the first value.

17. The computer usable program product of claim 11, further comprising:
computer usable code for determining whether the health data of the memory device indicates a wear on a cell due to cell to cell variation in the memory device from another memory operation in another cell in a neighborhood of the cell; and
computer usable code for leaving, responsive to determining that the health data of the memory device does not indicate the wear, the throttling rate unchanged at the first value.

18. The computer usable program product of claim 11, wherein the computer usable code is stored in a computer readable storage medium in a data processing system, and wherein the computer usable code is transferred over a network from a remote data processing system.

19. The computer usable program product of claim 11, wherein the computer usable code is stored in a computer readable storage medium in a server data processing system, and wherein the computer usable code is downloaded over a network to a remote data processing system for use in a computer readable storage medium associated with the remote data processing system.

20. A data processing system for managing a lifespan of a memory device, the data processing system comprising:
a storage device including a storage medium, wherein the storage device stores computer usable program code; and
a processor, wherein the processor executes the computer usable program code, and wherein the computer usable program code comprises:
computer usable code for setting, using a processor, at an application executing in a data processing system, a throttling rate to a first value for processing memory operations in the memory device, the setting using a health data of the memory device for determining the first value;
computer usable code for determining whether a memory operation can be performed on the memory device within the first value of the throttling rate, the first value of the throttling rate allowing a first number of memory operations using the memory device per time period; and
computer usable code for performing, responsive to the determining being negative, the memory operation using a secondary storage device.
